(19) United States
(12) Patent Application Publication
(10) Pub. No.: US 2011/0136641 A1
(43) Pub. Date: Jun. 9, 2011

(54) PACKAGE BOX AND BOX FORMING MEMBER

(75) Inventors: Yoon Hyung LEE, Seoul (KR); Jin Sun KIM, Seoul (KR); Su Mi PARK, Seoul (KR)

(73) Assignee: SAMSUNG ELECTRONICS CO., LTD., Suwon-si (KR)

(21) Appl. No.: 12/952,473

(22) Filed: Nov. 23, 2010

(30) Foreign Application Priority Data
Dec. 7, 2009 (KR) 10-2009-0120695

(51) Int. Cl. B31B 3/26

(52) U.S. Cl. 493/162

(57) ABSTRACT

A box forming member includes a plurality of surfaces parts which are configured to fold with respect to each other to form a package box. At least one of the surface parts has a first surface having a first design formed thereon, and a second surface opposite to the first surface and having a second design formed thereon, and the first design is different from the second design, such that the box forming member is foldable into two package boxes having different designs on the outside thereof.

### CROSS-REFERENCE TO RELATED APPLICATION

This application claims priority from Korean Patent Application No. 2009-0120695, filed on Dec. 7, 2009 in the Korean Intellectual Property Office, the disclosure of which is incorporated herein by reference.

### BACKGROUND

1. Field

Apparatuses and methods consistent with exemplary embodiments relate to a package box used to pack a product and a box forming member to form the package box.

2. Description of the Related Art

A box forming member is a sheet-shaped member, made of paper product, which is used to form a package box in which a product can be packed. Such a sheet-shaped box forming member is folded into a package box having a hexahedral structure, so that the resultant package box is capable of packing a product therein.

A design, such as various letters and pictures, to describe or decorate the product can be provided on a surface of the box forming member, which forms the outer surface of the resultant package box.

### SUMMARY

One or more exemplary embodiments provide a box forming member which is foldable into a package box to serve various purposes.

One or more exemplary embodiments also provide a box forming member in which a design provided on the outer surface of a package box is changeable as necessary.

In accordance with one aspect of an exemplary embodiment there is provided a box forming member which is sheet-shaped, the box-forming member including a plurality of surface parts which are configured to fold with respect to each other to form a package box. At least one of the surface parts has a first surface having a first design formed thereon, and a second surface being opposite to the first surface and having a second design formed thereon, and the first design is different from the second design.

The box forming member may also include a lower surface part configured to form a lower surface of the package box, two side surface parts which extend from opposite sides of the lower surface part and are configured to fold with respect to the lower surface part. Two front hanging parts extend from front ends of respective side surface parts, wherein the two front hanging parts are configured to interlock with each other. Two rear hanging parts extend from rear ends of respective side surface parts, wherein the two rear hanging parts are configured to interlock with each other.

Each of the front hanging parts has a front hanging groove which is configured to interlock with the front hanging groove in the other of the two front hanging parts. Each of the rear hanging parts has a rear hanging groove in the which is configured to interlock with the rear hanging groove in the other of the two rear hanging parts.

The box forming member may further include a front surface part which extends from a front of the lower surface part and is configured to fold with respect to the lower surface part to form a front surface of the package box, and a support part which extends from the front surface part and is configured to fold with respect to the front surface part over the front hanging parts.

The box forming member may further include a rear surface part which extends from a rear of the lower surface part and is configured to fold with respect to the lower surface part to form a rear surface of the package box, an outer cover part which extends from the rear surface part and is configured to fold with respect to the rear surface part to form an upper surface of the package box, and an insertion part which extends from the outer cover part and is insertable into a slit in the support part.

The box forming member may further include a locking part which extends from the front surface part, and a locking slit provided at a junction between the outer cover part and the insertion part such that the locking part is insertable into the locking slit.

The box forming member may further include two inner cover parts each extending from a respective one of the two side surface parts, wherein the two inner cover parts are configured to fold with respect to the side surface parts to at least partially cover a cavity formed in the package box.

An arc-shaped slit may be provided in each of the inner cover parts.

Junctures between the surface parts each comprise a folding structure having a first surface with is concave and a second surface, opposite the first surface, which is convex.

In accordance with an aspect of another exemplary embodiment, there is provided a method of forming a package box including folding a box forming, including a plurality of surface parts, wherein at least one of the plurality of surface parts comprises a first surface having a first design formed thereon, and a second surface opposite to the first surface and having a second design formed thereon, wherein the first design is different from the second design.

The folding the box forming member may include folding the box forming member such that the first surface having the first design formed thereon forms an outer surface of the package box.

The folding the box forming member may include folding the box forming member such that the second surface having the second design formed thereon forms an outer surface of the package box.

### BRIEF DESCRIPTION OF THE DRAWINGS

The above and/or other aspects will become apparent and more readily appreciated from the following description of exemplary embodiments, taken in conjunction with the accompanying drawings of which:

FIGS. 1 and 2 are development views illustrating both surfaces of a box forming member in accordance with an exemplary embodiment;

FIGS. 3 to 7 are perspective views illustrating a process of forming a package box by folding the box forming member in one direction;

FIG. 8 is a perspective view illustrating a package box formed by folding the box forming member in the opposite direction; and

FIG. 9 is an enlarged sectional view illustrating a folding part provided on each folded region.

### DETAILED DESCRIPTION

Reference will now be made in detail to exemplary embodiments which are illustrated in the accompanying drawings, wherein like reference numerals refer to like elements throughout.

Hereinafter, a box forming member in accordance with an exemplary embodiment will be described in detail with reference to the accompanying drawings.

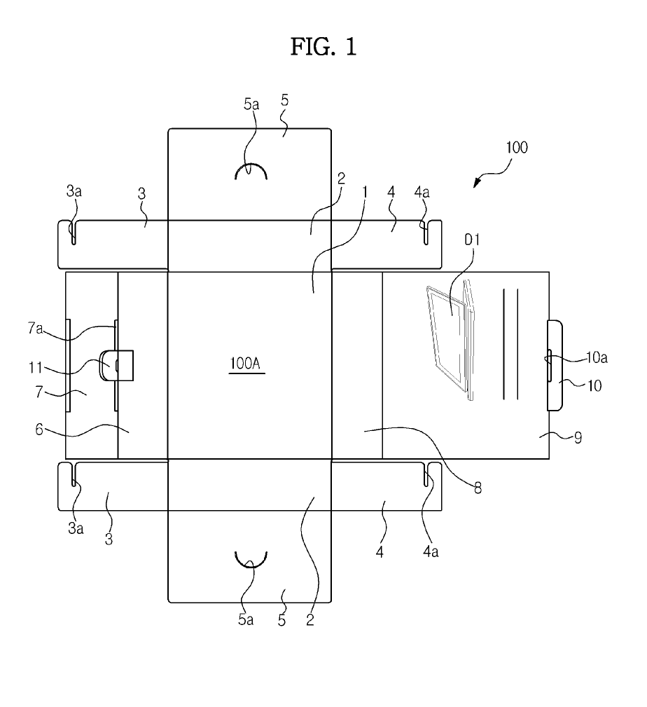

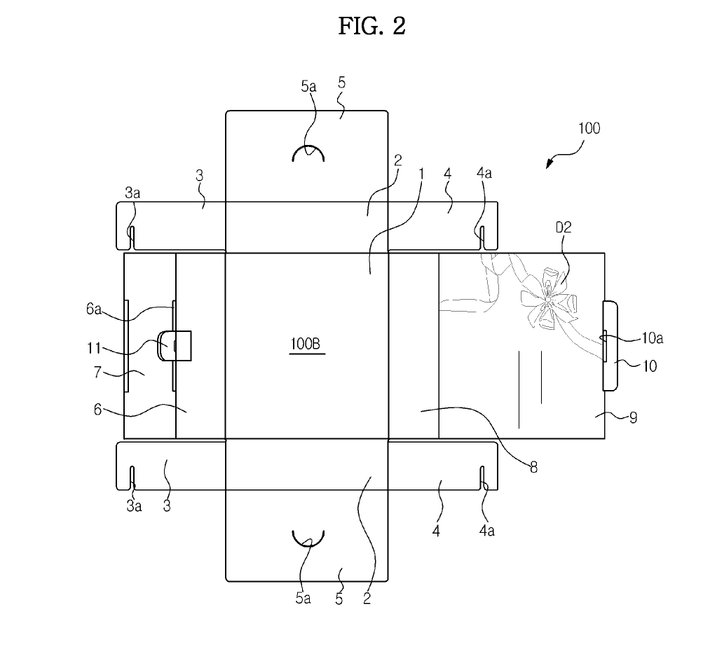

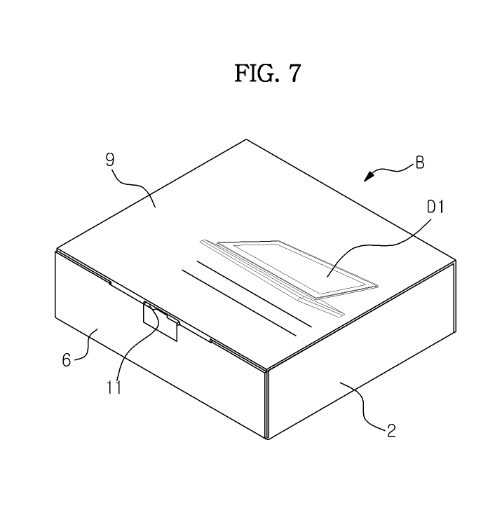

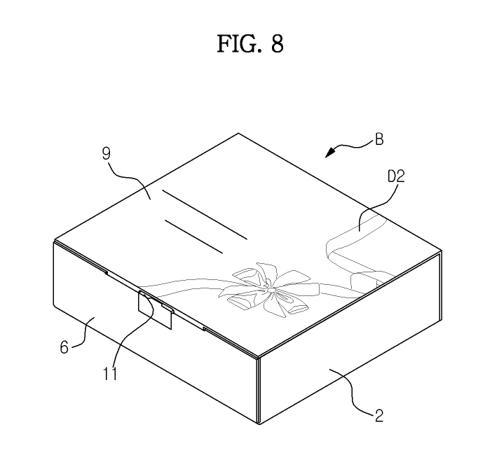

As shown in FIGS. 1 and 2, a box forming member 100 is sheet-shaped, is foldable into a package box B of FIGS. 7 and 8, and is provided with surfaces having different designs formed thereon. That is, the surfaces of the box forming member 100 include a first surface 100A provided with a first design D1 formed thereon and a second surface 100B provided with a second design D2 formed thereon. Thereby, according to folding directions, the first design D1 may be provided on the outer surface of the package box B, or the second design D2 may be provided on the outer surface of the package box B. In this embodiment, the first design D1 is a design which indicates functions of a product, and the second design D2 is a decorative design for use as gift packaging.

Therefore, one box forming member 100 may be alternatively folded into two different package boxes B having different purposes. Further, a package box B for one purpose obtained by folding the box forming member 100 in one direction may be easily changed into another package box B for a different purpose by unfolding the box forming member 100 and then re-folding the box forming member 100 in the opposite direction. In other words, the resultant package box B box is reversible.

The box forming member 100 includes a lower surface part 1 to form the lower surface of the package box B, a pair of side surface parts 2 extended from both side ends of the lower surface part 1 in both side directions and folded vertically to form both side surfaces of the package box B, a pair of front hanging parts 3 extending forward from the two side surface parts 2 and attached to and supported by front portions of the two folded side surface parts 2, to support the front portions of the two folded side surface parts 2 when folded into the package box B, and a pair of rear hanging parts 4 extending backward from the two side surface parts 2 and attached to and supported by rear portions of the two folded side surface parts 2, to support the rear portions of the two folded side surface parts 2 when folded into the package box B. Here, front hanging grooves 3a, provided on each of the front hanging parts 3, enable the two front hanging parts 3 to be interlocked with each other, and rear hanging grooves 4a, provided on each of the rear hanging parts 4, enable the two rear hanging parts 4 to be interlocked with each other.

A pair of inner cover parts 5 extended in both side directions from the side surface parts 2 and can be folded with respect to the side surface parts 2 to partially cover a portion of a product contained in the package box B. An arc-shaped insertion slit 5a into which a product manual or warranty may be inserted is provided on each of the two inner cover parts 5.

The box forming member 100 further includes a front surface part 6 extending forward from the front end of the lower surface part 1 to form a front surface of the package box B. A support part 7 extends forward from the front end of the front surface part 6 and is foldable, with respect to the front surface part 6, to be disposed on rear (inner) surfaces of the two front hanging parts 3, when folded. A rear surface part 8 extends backward from the rear end of the lower surface part 1 and is foldable with respect to the lower surface part 1 to form a rear surface of the package box B outside of the rear hanging parts 4.

The box forming member 100 further includes an outer cover part 9 extending backward from the rear end of the rear surface part 8 and foldable with respect to the rear surface part 8 to form the upper surface (lid) of the package box B. An insertion part 10 extends backward from the rear end of the outer cover part 9, and is foldable with respect to the outer cover part to be inserted into a slit 7a in the support part 7 to cause the rear end of the outer cover part 9 (i.e., the tip of the outer cover part 9 forming the front end of the outer cover part 9 under the folded state) to be interlocked with the support part 7.

In order to maintain the closed state of the outer cover part 9 with respect to the support part 7, a locking part 11 extends from the front surface part 6, and a locking slit 10a into which the locking part 11 is insertable is provided at the junction between the outer cover part 9 and the insertion part 10.

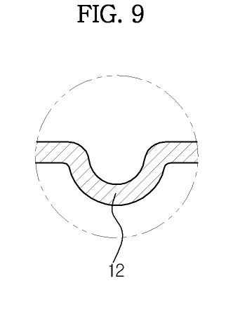

As shown in FIG. 9, each of junctions between respective surfaces to be folded has a folding structure such that it is easily folded in one direction and also in the opposite direction. In this embodiment, the folding structure 12 is formed such that one surface thereof is concave and the other surface thereof is convex, thereby allowing the box forming member 100 to be easily deformed in both directions.

Hereinafter, a process of producing the package box B by folding the box forming member 100 in accordance with this embodiment will be described with reference to the accompanying drawings.

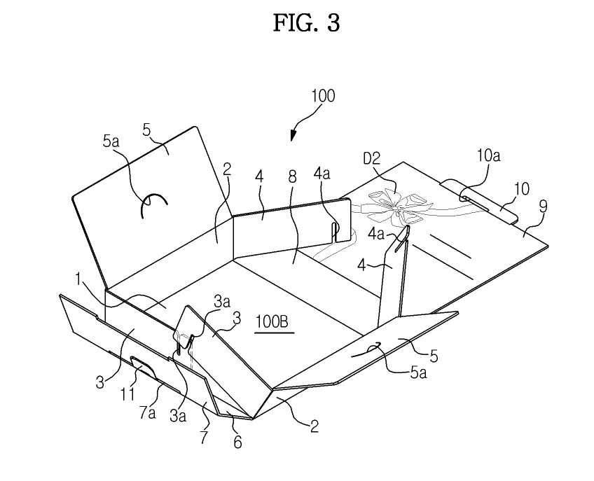

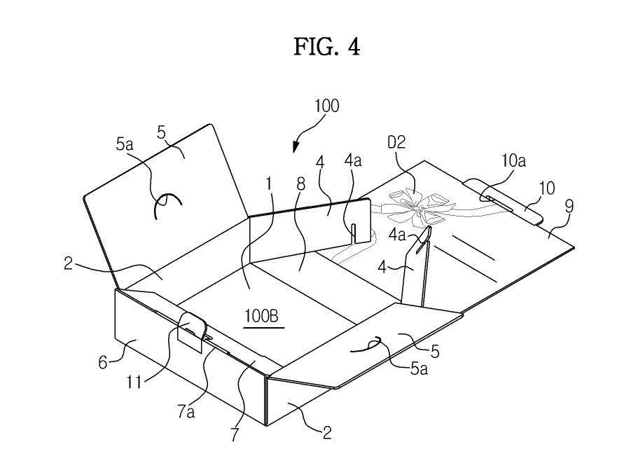

First, as shown in FIG. 3, the side surface parts 2 of the box forming member 100 are folded with respect to the lower surface part 2, such that the side surface parts 2 are disposed vertically. Thereafter, the front hanging parts 3, formed at the front portions of the side surface parts 2, are folded such that the front hanging grooves 3a provided in the two front hanging parts 3 are interlocked, and thus the front ends of the two side surface parts 2 are supported by the front hanging parts 3. The front surface part 6 and the support part 7 are folded such that the front surface part 6 is disposed in front of (outside) the two front hanging parts 3 and the support part 7 is disposed in rear of (inside) the two front hanging parts 3, as shown in FIG. 4.

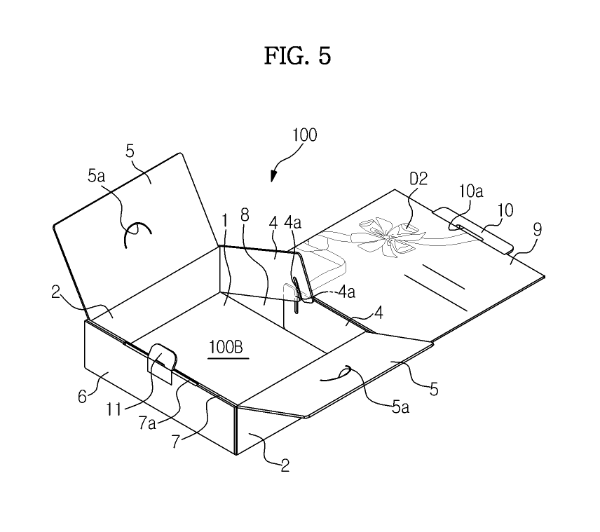

Thereafter, as shown in FIG. 5, the rear hanging parts 4, formed at the rear portions of the side surface parts 2, are folded such that the rear hanging grooves 4a provided on the two rear hanging parts 4 are interlocked with each other, and thus the rear ends of the two side surface parts 2 are supported by the rear hanging parts 4.

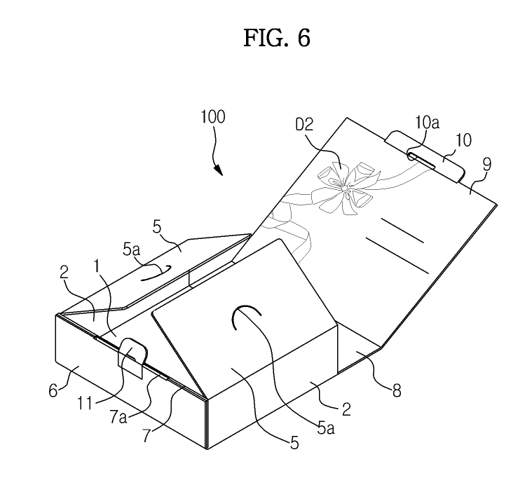

In the above-described state, the two inner cover parts 5 extend upwardly from the upper ends of the two side surface parts 2 and are folded with respect to the side surface parts 2 such that the upper portion of an interior space, formed by the lower surface part 1, the two side surface parts 2, the front surface part 6, and the rear surface part 8, is covered by the two inner cover parts 5, as shown in FIG. 6.

Thereafter, the rear surface part 8 and the outer cover part 9 are folded such that the outer cover part 9 is disposed on the upper (outer) surfaces of the inner cover parts 5, the insertion part 10 is inserted into the rear surface of the support part 7, and then the locking part 11 is inserted into the locking slit 10a, thereby completing the formation of a package box B provided with the first design D1 on the outer surface thereof, as shown in FIG. 7.

The package box B obtained by folding the sheet-shaped box forming member 100 may be unfolded by carrying out the above-described process in reverse order. After the package box B is unfolded, another package box B for a different purpose provided with the second design D2 on the outer surface thereof can be obtained by re-folding the box forming member 100 in the opposite direction.

As is apparent from the above description, a box forming member in accordance with an exemplary embodiment is provided with different designs formed on the surfaces thereof, and thus allows one of the two designs to be provided on the outer surface of a package box, obtained by folding the box forming member, according to folding directions of the box forming member, thereby being capable of being folded into two package boxes having different purposes.

Even after the box forming member is folded in one direction to form one package box provided with one design formed on the outer surface thereof, the box forming member may be unfolded and then re-folded in the opposite direction to form another package box provided with a different design formed on the outer surface thereof, thereby easily changing the design on the package box as necessary.

Although exemplary embodiments have been shown and described, it would be appreciated by those skilled in the art that changes may be made in these embodiments without departing from the principles and spirit of the inventive concept, the scope of which is defined in the claims and their equivalents.

What is claimed is:

1. A box forming member, which is sheet-shaped, the box forming member comprising:
a plurality of surface parts which are configured to fold with respect to each other to form a package box,
wherein at least one of the plurality of surface parts comprises a first surface having a first design formed thereon, and a second surface opposite to the first surface and having a second design formed thereon, and the first design is different from the second design.

2. The box forming member according to claim 1, further comprising:
a lower surface part configured to form a lower surface of the package box;
two side surface parts which extends from opposite sides of the lower surface part and are configured to fold with respect to the lower surface part;
two front hanging parts each extending from a front end of a respective one of the two side surface parts, wherein the two front hanging parts are configured to interlock with each other; and
two rear hanging parts each extending from a rear end of a respective one of the two side surface parts, wherein the two rear hanging parts are configured to interlock with each other.

3. The box forming member according to claim 2, wherein:
each of the two front hanging parts comprises a front hanging groove which is configured to interlock with the front hanging groove in the other of the two front hanging parts, and
each of the two rear hanging parts comprises a rear hanging groove which is configured to interlock with the rear hanging groove in the other of the two rear hanging parts.

4. The box forming member according to claim 2, further comprising:
a front surface part which extends from a front of the lower surface part and is configured to fold with respect to the lower surface part to form a front surface of the package box; and
a support part which extends from the front surface part and is configured to fold with respect to the front surface part over the front hanging parts.

5. The box forming member according to claim 4, further comprising:
a rear surface part which extends from a rear of the lower surface part and is configured to fold with respect to the lower surface part to form a rear surface of the package box;
an outer cover part which extends from the rear surface part and is configured to fold with respect to the rear surface part to form an upper surface of the package box; and
an insertion part which extends from the outer cover part and is insertable into a slit in the support part.

6. The box forming member according to claim 5, further comprising:
a locking part which extends from the front surface part; and
a locking slit provided at a junction between the outer cover part and the insertion part such that the locking part is insertable into the locking slit.

7. The box forming member according to claim 2, further comprising two inner cover parts each extending from a respective one of the two side surface parts, wherein the two inner cover parts are configured to fold with respect to the side surface parts to at least partially cover a cavity formed in the package box.

8. The box forming member according to claim 7, wherein each of the two inner cover parts comprises an arc-shaped slit provided therein.

9. The box forming member according to claim 1, wherein junctures between the surface parts each comprise a folding structure having a first surface which is concave and a second surface, opposite the first surface, which is convex.

10. A method of forming a package box comprising:
folding a box forming member, comprising a plurality of surface parts, wherein at least one of the plurality of surface parts comprises a first surface having a first design formed thereon, and a second surface opposite to the first surface and having a second design formed thereon, and the first design is different from the second design.

11. The method according to claim 10, wherein folding the box forming member comprises folding the box forming member such that the first surface having the first design formed thereon forms an outer surface of the package box.

12. The method according to claim 10, wherein folding the box forming member comprises folding the box forming member such that the second surface having the second design formed thereon forms an outer surface of the package box.

13. A box forming member comprising:
a plurality of surface parts which are configured to fold with respect to each other, each comprising substantially planar first surfaces and substantially planar second surfaces opposite each other; and
a plurality of folding structures, each disposed at a juncture between two adjacent surface parts, and each comprising a concave surface adjoining the first planar surfaces of adjacent surface parts and a convex surface adjoining the second planar surfaces of adjacent surface parts;
wherein the plurality of surface parts are configured to fold into a first substantially hexahedral box having the first surfaces on exterior sides thereof and are configured to fold into a second substantially hexahedral box having the second surfaces on exterior sides thereof.
